(19) United States
(12) Patent Application Publication
(10) Pub. No.: US 2010/0269106 A1
(43) Pub. Date: Oct. 21, 2010

(54) METHOD OF FINDING A SAFE TIME TO MODIFY CODE OF A RUNNING COMPUTER PROGRAM

(75) Inventor: Jeffrey Brian ARNOLD, Cambridge, MA (US)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, SUITE 280, WESTBOROUGH, MA, 01581, US

(73) Assignee: Ksplice, Inc., Cambridge, MA (US)

(21) Appl. No.: 12/427,732

(22) Filed: Apr. 21, 2009

(51) Int. Cl. G06F 9/44

(52) U.S. Cl. 717/168

(57) ABSTRACT

An improved method of modifying code of a running computer program is disclosed that includes the following steps, performed in the order indicated:

(a) determining the functions that will be modified due to desired changes to the running computer program;

(b) using the results of step (a), determining the start memory address and the end memory address of such a function; and

(c) using the results of step (b) determining, for such a function, whether an execution stack of any thread in the running computer program contains a specified numeric value; and

(d) using the results of step (c), determining whether the running computer program is currently in a state of execution such that the function can be modified safely.

A data storage medium containing computer instructions to perform the improved method is also disclosed.

### BACKGROUND OF THE INVENTION

When software developers correct a problem in the source code of a computer program (such as an operating system kernel), they typically create and distribute a patch, which consists of a set of changes to the source code. Software vendors or system administrators apply the patch to their copy of the source code, build a new binary copy of the computer program, and then distribute that new binary program to servers and end-user machines. The computer program must then be restarted in order to benefit from the update. Restarting programs in order to update them can cause undesirable disruption.

A “hot update” changes a running program without restarting it. A hot update system installs updates in a running program as follows. First, the hot update is loaded into the running program and initialized. The hot update then locates the code entry points in the running program's memory that are to be modified. Then, at a safe time, the hot update will insert trampolines (jump instructions) at those locations. These trampolines will direct execution away from the obsolete code to new code, located elsewhere, that has been loaded into program memory as part of the hot update.

A key problem in this process is finding a safe time to modify the code of the running program by inserting the trampolines. It is in general unsafe to insert trampolines into a function that is in the process of being executed by any program thread. There are two common reasons why inserting trampolines into a function that is being executed by a program thread is unsafe. First, inserting the trampolines involves overwriting some of the code of the running function at each of the entry points, which could result in incorrect behavior if the thread executing the running function later attempts to execute any of the overwritten code. Second, many patches must be applied to multiple functions atomically (in an all-or-nothing fashion) in order to ensure safety, and the transition will not be atomic if a thread was in the process of executing a function being patched when the trampolines were inserted. For example, if a patch changes the locking semantics of a set of functions, then a deadlock could occur if the trampolines were inserted while one of the functions was being executed.

Existing hot update systems (e.g., OPUS) have addressed the problem of finding a safe time to apply a hot update by requiring certain program execution metadata, specifically a frame pointer chain, to be available for each program thread. This metadata is used to perform a specific check for every frame associated with every thread stack. Specifically, the check is whether the frame instruction pointer falls within any of the patched functions.

Because many deployed systems do not have this metadata available, existing techniques are commonly ineffective for performing the hot update safety check, preventing these systems from being updated using hot updates.

### BRIEF SUMMARY OF THE INVENTION

The present invention is an improved method for safely performing hot updates to a running computer program. Specifically, the present invention is a technique for finding a safe time to modify the executable code of a running computer program. Unlike existing techniques, the present invention works even in the absence of detailed program execution metadata, such as a frame pointer chain.

### BRIEF DESCRIPTION OF THE DRAWING

The present invention will become more fully understood from the detailed description given below and the accompanying drawing, which are given by way of illustration only and thus are not limitative of the present invention, wherein:

FIG. 1 illustrates a data storage medium having instructions stored therein for a computer to perform the method of the present invention.

### DETAILED DESCRIPTION

As used herein, the term “computer program” or “program” refers to any computer program, including an operating system kernel.

The present invention is a novel method for finding a safe time to apply a hot update that is effective even in the case wherein that frame pointer metadata is not available.

First, the present invention determines a list of functions that will be modified as part of the changes to the running computer program. This list can be determined using any technique, such as an analysis of a source code patch.

Using this list of functions that will be modified, the present invention then determines the start memory address and the end memory address of each function that will be modified in the running computer program. These memory addresses can be determined using any technique, such as looking up the function's address in a program symbol table.

Using those start and end memory addresses for each function that will be modified, the present invention determines whether the execution stack of any thread in the running computer program contains any numeric value, located anywhere in the stack, that is greater than or equal to the start address of the function and less than the end address of the function.

Using this information about whether any execution stack contains such a value, the present invention determines whether the running computer program is currently in a state of execution such that it can be modified safely. Specifically, if any execution stack contains such a value, the program is not in a state of execution such that it can be modified safely. Because the execution state of program threads changes over time, the update process can be repeated at one or more later times in case the condition is not currently satisfied.

The present invention will always detect a conflict if a conflict does exist, regardless of whether the frame pointer metadata is available.

Thus, the improved method of the present invention can be summarized as follows:

In a method of modifying code of a running computer program so as to modify the running computer program without having to restart the running computer program for changes to the running computer program to take effect, the improvement of including the following steps in said method:

step (a)—determining a list of functions that will be modified as part of said changes to the running computer program; and

step (b)—using the results of step (a), determining, for a function that will be modified as part of said changes to the running computer program, the start memory address of said function in said running computer program and the end memory address of said function in said running computer program; and

step (c)—using the results of step (b), determining, for a function that will be modified as part of said changes to the running computer program, whether an execution stack of any thread in the running computer program contains, located in any position on said execution stack, any numeric value that:
(1) is greater than or equal to said start address of said function; and
(2) is less than said end address of said function; and

step (d)—using the results of step (c), specifically, based on whether both condition (c)(1) and condition (c)(2) are true, determining whether said running computer program is currently in a state of execution such that it can be modified safely. If no execution stack contains such a numeric value, the program is in a state of execution such that it can be modified safely.

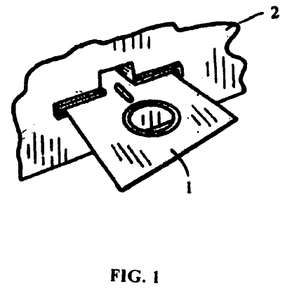

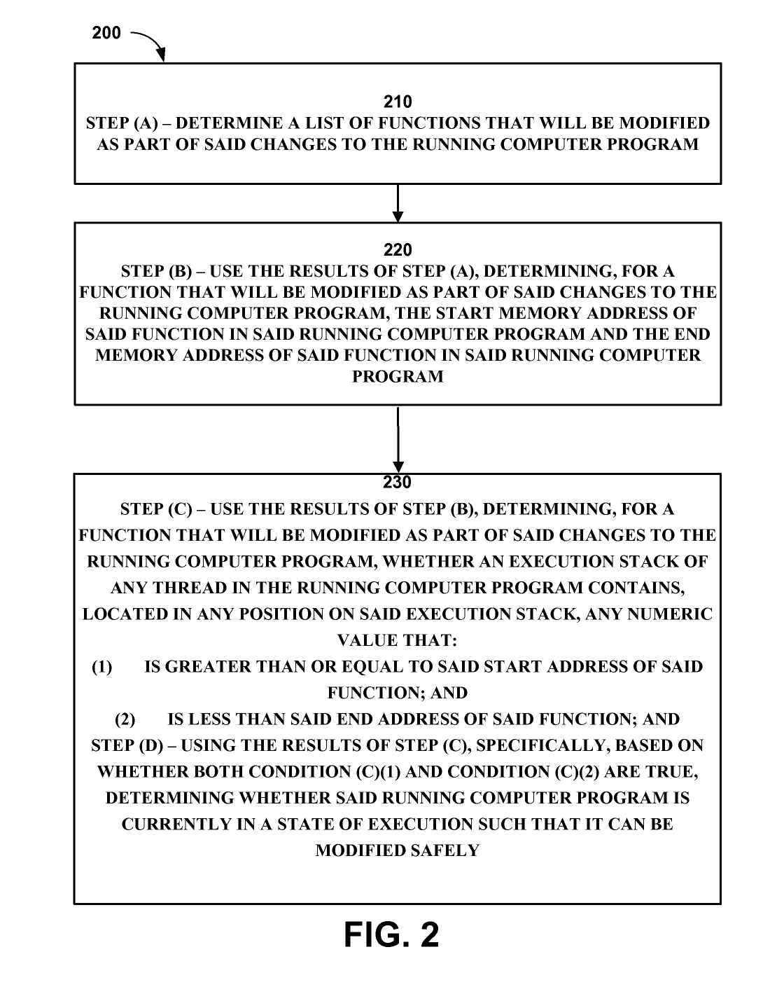

FIG. 1 illustrates a data storage medium 1 having instructions stored therein for a computer 2 to perform the method of the present invention

The invention being thus described, it will be obvious that the same may be varied in many ways. Such variations are not to be regarded as a departure from the spirit and scope of the invention. Rather, the scope of the invention shall be defined as set forth in the following claims and their legal equivalents. All such modifications as would be obvious to one skilled in the art are intended to be included within the scope of the following claims.

1. (canceled)

2. (canceled)

3. A method comprising:
identifying a portion of executable code to be updated in a running computer program; and
determining whether it is safe to modify the executable code of the running computer program without having to restart the running computer program.

4. The method of claim 3 further comprising applying a hot update to the executable code.

5. The method of claim 3, wherein identifying a portion of executable code to be updated in a computer program includes determining a list of functions to modify as part of changes to the executable code.

6. The method of claim 5 further comprising determining a start memory address and an end memory address in the portion of executable code from a program symbol table for each of the functions in the list.

7. The method of claim 5, wherein determining whether it is safe to modify the executable code of the computer program includes determining whether execution stacks of executable threads in the running computer program include a numeric value that is within the range of the start memory address and the end memory address for each of the functions in the list.

8. The method of claim 7 further comprising applying a hot update to the executable code in response to determining that the execution stacks of the executable threads include numeric values that are outside the range of the start memory address and the end memory address for each of the functions in the list.

9. The method of claim 3 further comprising repeating the step of determining whether it is safe to modify the executable code of the computer program.

10. The method of claim 4, wherein applying a hot update to the executable code includes applying the hot update without having to restart the computer program.

11. The method of claim 3 further comprising determining whether an execution stack of the portion of executing code of the computer program maintains a reference to the range of addresses for each of a plurality of functions to be updated as part of the modifications to the executable code.

12. A method comprising:
determining at least one function in a running computer program to be modified;
determining whether the running computer program is currently in a state of execution such that it can be modified safely; and
modifying code of the running computer program so as to modify the running computer program without having to restart the running computer program in response to determining that the running computer code can be safely modified.

13. The method of claim 12, wherein determining whether the running computer program is currently in a state of execution such that it can be modified safely includes determining, for the function to be modified, whether an execution stack of a thread in the running computer program includes a numeric value on the execution stack that could prevent safe modification.

14. The method of claim 13, wherein determining whether the execution stack includes a numeric value on the execution stack that could prevent safe modification includes:
determining, for the function that will be modified as part of changes to the running computer program, a start memory address of the function in the running computer program and an end memory address of the function in the running computer program; and
determining, for the function that will be modified as part of the changes to the running computer program, whether the execution stack includes a numeric value that is greater than or equal to the start address of the function and is less than the end address of the function.

15. The method of claim 14, wherein the numeric value is located at any position on the execution stack.

16. A computer program product having a computer-readable medium including computer program logic encoded thereon that, when executed on a computer system provides a method of modifying code of a running computer program that causes the computer system to perform operations of:
determining a list of functions that will be modified as part of changes to the running computer program;
determining, for a function that will be modified as part of the changes to the running computer program, a start memory address of the function in the running computer program and an end memory address of the function in the running computer program; and
determining, for the function that will be modified as part of the changes to the running computer program, whether an execution stack of a thread in the running computer program includes a numeric value that:
(1) is greater than or equal to the start address of the function; and
(2) is less than the end address of the function; and
determining whether the running computer program is currently in a state of execution such that it can be modified safely.

17. The method of claim 16, wherein the numeric value is located at any position on the execution stack.
